(19) United States
(12) Patent Application Publication
(10) Pub. No.: US 2009/0265307 A1
(43) Pub. Date: Oct. 22, 2009

(54) SYSTEM AND METHOD FOR AUTOMATICALLY PRODUCING FLUENT TEXTUAL SUMMARIES FROM MULTIPLE OPINIONS

(76) Inventors: Kenneth REISMAN, Brooklyn, NY (US); Samidh CHAKRABARTI, New York, NY (US)

Correspondence Address: FULBRIGHT & JAWORSKI, LLP, 666 FIFTH AVE, NEW YORK, NY, 10103-3198, US

(21) Appl. No.: 12/426,603

(22) Filed: Apr. 20, 2009

Related U.S. Application Data
(60) Provisional application No. 61/124,649, filed on Apr. 18, 2008.

(51) Int. Cl. G06F 17/30

(52) U.S. Cl. 707/2

(57) ABSTRACT

A system and method for automatically generating fluent textual summary from multiple opinions. The opinion summarization system comprises a feature extractor, a text generator and a feature analysis storage. The feature extractor retrieves textual opinions from an opinion database relevant to a predetermined topic and analyzes retrieved textual opinions relevant to the predetermined topic by extracting a plurality of predetermined features from the retrieved textual opinions. The feature analysis storage stores the plurality of predetermined features extracted from the retrieved textual opinions. The text generator generates an opinion summary that summarizes all of the retrieved textual opinions relevant to the predetermined topic by converting the plurality of predetermined features extracted from the retrieved textual opinions into the opinion summary comprising a fluent block of text.

### RELATED APPLICATION

The present application claims the benefit of U.S. Provisional Application Ser. No. 61/124,649 filed Apr. 18, 2008, which is incorporated herein by reference in its entirety.

### RELATED ART

The present invention relates to a system and method for automatically generating fluent textual summaries from multiple opinions.

There are analytical systems for analyzing and comparing opinions on the web. Certain system can extract product features from the various product reviews. However, none of these systems can analyze multiple opinions and automatically generate fluent textual summaries from these multiple opinions.

Accordingly, the claimed invention proceeds upon the desirability of providing an opinion summarization system and method for automatically generating fluent textual summaries from multiple opinions.

### OBJECTS AND SUMMARY OF THE INVENTION

Therefore, it is an object of the claimed invention to provide a system and method for automatically generating fluent textual summary from multiple opinions.

In accordance with an exemplary embodiment of the claimed invention, the opinion summarization system for automatically generating fluent textual summary from multiple opinions comprises a feature extractor, a text generator and an opinion summary database. The feature extractor retrieves textual opinions from an opinion database relevant to a predetermined topic and analyzes retrieved textual opinions relevant to the predetermined topic by extracting a plurality of predetermined features from the retrieved textual opinions. Additionally, the feature extractor stores the plurality of predetermined features in a feature analysis storage. The text generator generates an opinion summary that summarizes all of the retrieved textual opinions relevant to the predetermined topic by converting the plurality of predetermined features extracted from the retrieved textual opinions into the opinion summary comprising a fluent block of text.

In accordance with an exemplary embodiment of the claimed invention, the computer based method for automatically generating fluent textual summary from multiple opinions comprises the steps of retrieving textual opinions, generating opinion summary and storing the opinion summary. The textual opinions relevant to a predetermined topic are retrieved from the opinion database and analyzed by extracting a plurality of predetermined features from the retrieved textual opinions, which are stored in a feature analysis storage. An opinion summary is generated that summarizes all of the retrieved textual opinions so relevant to the predetermined topic by converting the plurality of predetermined features extracted from the retrieved textual opinions. The opinion summary comprises a fluent block of text and is stored in the opinion summary.

In accordance with an exemplary embodiment of the claimed invention, the computer readable medium comprises code for automatically generating a fluent textual summary from multiple opinions. The code comprises computer executable instructions for retrieving textual opinions, generating opinion summary and storing the opinion summary. The textual opinions relevant to a predetermined topic are retrieved from the opinion database and analyzed by extracting a plurality of predetermined features from the retrieved textual opinions, which are stored in a feature analysis storage. An opinion summary is generated that summarizes all of the retrieved textual opinions relevant to the predetermined topic by converting the plurality of predetermined features extracted from the retrieved textual opinions. The opinion summary comprises a fluent block of text and is stored in the opinion summary.

In accordance with an exemplary embodiment of the claimed invention, the text generator comprises a grammar generator for generating a set of text production rules for the plurality of predetermined features extracted from the retrieved textual opinions and a grammar interpreter for evaluating the set of text production rules into a fluent block of text. The set of production rules satisfies text generation criteria of relevancy, fluency, variety and robustness.

In accordance with an exemplary embodiment of the claimed invention, the feature extractor comprises at least one of the following: a feature based sentiment extractor for generating a list of topic attributes with a sentiment score and sample size associated each topic attribute from said retrieved textual opinions; a quotation extractor for generating a list of textual quotations and extracted adjectives from said retrieved textual opinions; a statistical sentiment analyzer for generating overall sentiment statistics; and a factual information extractor for generating a set of relevant background facts about said predetermined topic.

In accordance with an exemplary embodiment of the claimed invention, the opinion summarization system comprises an opinion aggregation system for aggregating multiple textual opinions on a topic received from a multiple sources over a communications lo network into the opinion database. The opinion aggregation system converts each textual opinion into a standard format and stores formatted opinion in the opinion database.

In accordance with an exemplary embodiment of the claimed invention, the opinion summarization system comprises a distribution system for distributing or transmitting the opinion summary to user over a communications network; The distribution system is operable to solicit opinions for insertion into the opinion database over the communications network and to receive request for an opinion summary from the user over the communications network.

Various other objects, advantages and features of the present invention will become readily apparent from the ensuing detailed description, and the novel features will be particularly pointed out in the appended claims.

### BRIEF DESCRIPTION OF FIGURES

The following detailed descriptions, given by way of example, and not intended to limit the claimed invention solely thereto, will be best be understood in conjunction with the accompanying figures:

FIG. 1 is an overall flow diagram of information through the opinion summarization system 1000 in accordance with an exemplary embodiment of the claimed invention;

FIG. 2 is a flow diagram of an exemplary use scenario in accordance with an exemplary embodiment of the claimed invention;

FIG. 3 is an exemplary opinion format in accordance with an exemplary embodiment of the claimed invention;

FIG. 4 is a block diagram illustrating a feature extractor 1200 in accordance with an exemplary embodiment of the claimed invention;

FIG. 5 is a block diagram illustrating a text generator 1300 in accordance with an exemplary embodiment of the claimed invention; and

FIG. 6 is an exemplary screenshot of a website incorporating the opinion summarization system 1000 in accordance with an embodiment of the claimed invention.

### DETAILED DESCRIPTION OF THE EMBODIMENTS

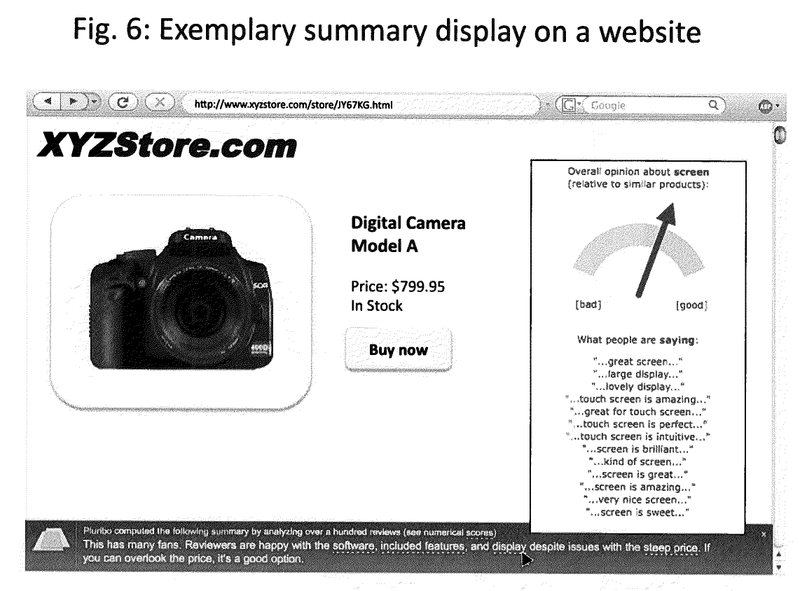

Turning now to FIG. 6, there is illustrated an exemplary screenshot of a website incorporating an opinion summarization system 1000 for automatically producing fluent textual summaries from multiple opinions in accordance with an embodiment of the claimed invention.

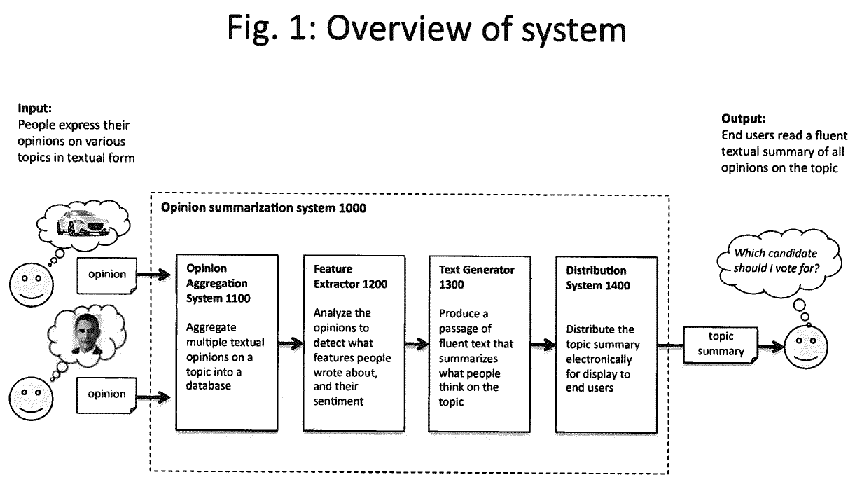

In accordance with an exemplary embodiment of the claimed invention, the opinion summarization system 1000 of FIG. 1 comprises an opinion aggregation system 1100, a feature extractor 1200, a text generator 1300, and a distribution system 1400. The opinion aggregation system 1100 receives textual opinions on any topic directly or indirectly from people who author opinions over a communications network 1500, preferably over the Internet, and stores the textual opinions in an opinion database 1110. For each topic, the feature extractor 1200 analyzes the relevant opinions and the text generator 1300 can produce a block of fluent text that summarizes what the all opinion authors have said. People who want to read a summary of the opinions on a given topic can request one through the opinion summarization system 1000, directly or indirectly, and the distribution system 1400 returns the relevant summary to the user.

For example, in accordance with an embodiment of the claimed invention, the opinion summarization system 1000 generates a following summary of the opinions for a particular model of digital camera: People were generally excited about the Canon PowerShot™ Pro's value for the money and versatility, though a few complained about photo quality and bulky size. One person remarked, “Loaded with features, but don't expect amazing results”.

The primary inputs to the opinion summarization system 1000 are opinions from persons or organizations. As used in the claimed invention, an opinion can express a view of a person or organization towards a specific topic, contain linguistic, numeric, or other information to identify the view that is expressed, contain linguistic, numeric, or other information to identify the topic, or contain “meta” information on the production of the opinion itself, such as the name of the author, the date the opinion was produced, etc. The opinion summarization system 1000 can accept opinions on any topic, as long as the topic has a unique name or identifier.

In accordance with an exemplary embodiment of the claimed invention, the opinion aggregation system 1100 collects opinions from multiple sources. Sources can include, but not limited to: opinions entered by individual through a web portal, opinions extracted from the internet, using a web crawler, and opinions licensed from a third party, using an electronic API (Application Programming Interface). The opinion aggregation system 1100 processes and converts each opinion into a standard format. For each candidate opinion, in accordance with an exemplary embodiment of the claimed invention, the opinion aggregation system 1100 can accept or reject a candidate opinion. If a candidate opinion is accepted, the opinion aggregation system 1100 may modify/convert content of the opinion to fit a specified format suitable for processing by the opinion summarization system 1000.

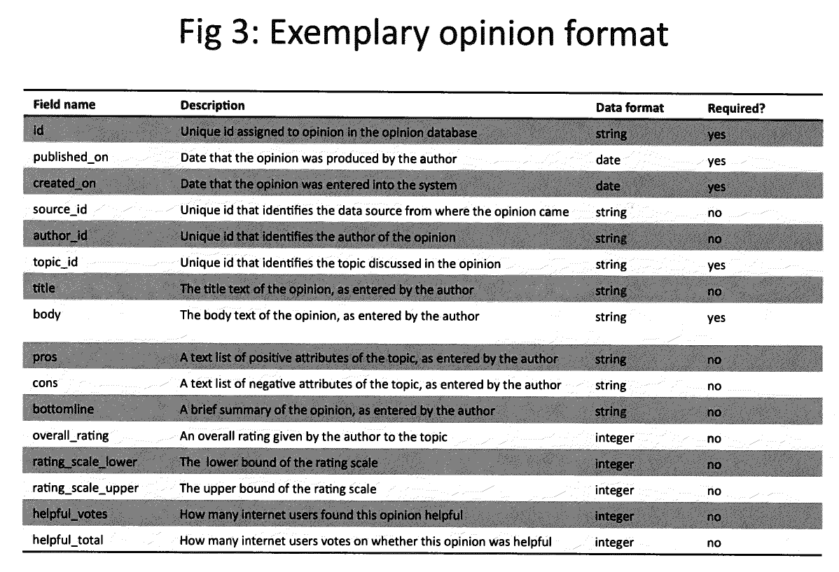

In accordance exemplary embodiment of the claimed invention, the standard format of each opinion includes fields representing the topic of the opinion, its written content, and the date the opinion was produced. It can also include author information and numerical ratings. An exemplary opinion format in accordance with an embodiment of the claimed invention is shown in FIG. 3.

The opinion aggregation system 1100 stores the formatted opinion into a searchable opinion database 1110 where it can be retrieved for processing by the feature extractor 1200. The opinion database 1110 is a storage and retrieval system for formatted opinions. It is appreciated that the opinion database 1110 can be implemented with any known storage device, such as disk storage, file storage system, memory, flash drive and the like. In accordance with an exemplary embodiment of the claimed invention, the opinion database 1110 can be implemented as a file system with an XML file for each opinion or as a database system with a database record for each opinion.

The feature extractor 1200 analyzes the opinions in the opinion database 1120 that are relevant to a topic X, and outputs new data structures that summarize or generalize over these extracted opinions relating to topic X. In accordance with an exemplary embodiment of the claimed invention, the analysis can cover many different features of the material discussed in the opinion text, including (but not limited to): what people think about topic X; how much people liked or disliked X; why they liked or disliked about X; what particular aspects of the X people liked, disliked, or commented on; how they compared X to other topics; quotations of what people said about X; and whether sentiment about X is increasing or decreasing over time.

In accordance with an exemplary embodiment of the claimed invention, the feature extractor 1200 implements a suitable algorithm to perform the extraction of each desired feature from the opinion text. The output of the various feature extractions can include any data structure, as long as the data structure is an accepted as input by the text generator 1300.

The feature extraction process of the feature extractor 1200 can be triggered in several different ways; the selection of triggering mechanism depends on the system operator's desired response time, storage efficiency, and computational efficiency.

Trigger example 1: Feature extraction by the feature extractor 1200 is triggered by the insertion of new opinions into the opinion database 1110. Each time a new opinion or batch of opinions is inserted into or received by the opinion aggregation system 1100, the feature extractor 1200 analyzes the new data and caches the result for immediate or later processing by the text generator 1300.

Trigger example 2: Feature extraction by the feature extractor 1200 is triggered by a request for a topic summary. Each time, a user requests a summary on a topic, the feature extractor 1200 analyzes the relevant opinions and feeds the result to the text generator 1300 for immediate processing.

The text generator 1300 converts the set of feature analysis on a given topic into an opinion summary for that topic, including a fluent block of text. There may be a great deal of information contained in the set of feature analysis. To generate a quality opinion summary, in accordance with an exemplary embodiment of the claimed invention, the text generator 1300 considers the following criteria:

Relevancy: Select a relevant subset of the information in the feature analyses for inclusion in the opinion summary.

Fluency: Express the relevant information in a fluent text paragraph that reads naturally to a native human speaker. Ideally, the paragraph should look as though a native human speaker composed it.

Variety. Vary the content and language of the fluent text paragraph so that opinion summaries for different topics are unique, and not repetitive. Preferably, the text generator 1300 generates opinion summaries such that it is not readily apparent to native speaker that these opinion summaries were produced algorithmically or machine-generated.

Robustness: Though the quality and quantity of information contained in the set of feature analyses might vary, the text generator 1300 still produces a valid text output. Preferably, the text generator. 1300 produces valid output even if certain data (such as the feature-based sentiment analysis, or the title of the given topic) is missing from the set of feature analyses.

As with feature extraction, the text generation process of the text generator 1300 can be triggered in several different ways; the selection of triggering mechanism depends on the system operator's desired response time, storage efficiency, and computational efficiency.

Trigger example 1: Generation of a topic summary is triggered by the output of the feature extractor 1200. Each time a new or updated feature analysis is generated, the text generator 1300 produces an updated summary and feeds it to the distribution system 1400.

Trigger example 2: Generation of a topic summary is triggered when the distribution system 1400 receives a request for a topic summary from a user. Each time a request for a topic summary is received by the distribution system 1400, the text generator 1300 pulls the relevant feature analyses (from the feature extractor 1200) and dynamically produces a new block of text.

An opinion summary is a text-based generalization/summary of what the opinions in the database 1110 have expressed on a particular topic (e.g., a particular model of digital camera, a particular presidential candidate), or on a broad topic (e.g., favorite digital cameras, comparison of political candidates). In accordance with an exemplary embodiment of the claimed invention, the text generator 1300 generates or produces a fluent textual paragraph, along with relevant background information and hypertext tags. The fluent text uses phrases that generalize and describe, for example:
How people feel about the topic (e.g., “people love digital camera A”);
What attributes of the topic people discussed, and how they described or felt about each attribute (e.g., “people were pleased with the photo quality and sleek design, but complained about the short battery life”);
Representative quotations from the underlying opinions;
Comparisons between one topic and other (e.g., “Overall, people preferred digital camera A to digital camera B”);
How aggregate sentiment has changed over time (e.g., “The initial excitement about digital camera A has waned over time”); and
Descriptive and/or factual details on the topic (e.g., “Digital camera A is a compact, silver point and shoot that retails for around $300” or “Digital camera A is currently a top seller at Amazon.com”).

The following are potential exemplary summaries (on various topics) produced or generated by the opinion summarization system 1000 of the claimed invention:
People were generally excited about the Canon PowerShot™ Pro's value for the money and versatility, though a few complained about photo quality and bulky size. One person remarked, “Loaded with features, but don't expect amazing results”.
The iPod™ Touch earned rave reviews for its exquisite interface and 0.3″ thin form factor. But even Apple loyalists concede that the price is too high. “Why not just get an iPhone™ for a hundred more bucks?” asks one customer. Perhaps as a result, sales seem to be declining recently.
Radiohead's “In Rainbows” album was released to much fanfare in January of 2008. REM fans like you were among the first to buy it—and they were not disappointed. Radiohead is at “their most conventionally gorgeous”, the believers proclaim, rockin' it with “dreamy tunes”.
Apparently, you either love or hate Starbucks.™ Half of people swear by the “delicious and reliable lattes”. But the other half, which includes most of your friends, is critical about the “cookie cutter” ambiance and the high prices.
Though eagerly anticipated, many fans were disappointed with the latest album from REM. “Boring,” “slow,” and “often whiny,” some fans worry that “REM is losing their touch.”

In accordance with an exemplary embodiment of the claimed invention, the text generator 1300 generates relevant background information to accompany the textual opinion summary, such as:
Numerical/statistical scores describing overall sentiment for the topic, or for each attribute of the topic;
Histograms describing the statistical distribution of sentiment for the topic, or for each attribute of the topic;
A list of sources names or source opinions used to compile the opinion summary; and
A list of related hypertext used to get further information on the topic.

It is appreciated that certain phrases in the textual portion of the opinion summary generated by the text generator 1300 can have hypertext tags to allow, for example:
Color coding certain phrases;
Clicking or hovering on a phrase that describes an attribute will cause a display of the statistical analysis or score for that attribute; and
Clicking or hovering on a phrase that describes an attribute will cause a display of source opinion that contributed to that phrase.

Additionally, in accordance with an exemplary embodiment of the claimed invention, the text generator 1300 generates an opinion summary so that the content is personalized for a particular user of the opinion summarization system 1000. The feature extractor 1200 and text generator 1300 filters or customizes the opinions that are used to generate the opinion summary (e.g., only use opinions from certain types of people, or from people who are similar to the user); filters or customizes topic, topic attributes, and topic comparisons discussed in the textual portion of the opinion summary to match the interests of the user; and customizes the language and vocabulary of the text of the opinion summary to the user.

In accordance with an exemplary embodiment of the claimed invention, the distribution system 1400 distributes and/or transmits the opinion summaries to users in a number of ways, for example: web server, which displays the opinion summaries on an internet site; Internet API (Application Programming Interface), which distributes the opinion summaries in electronic form for consumption by a third party computer program (or for display on a third party web site); Internet widgets, which display the opinion summaries on third party web site; and print publication.

In accordance with an exemplary embodiment of the claimed invention, the distribution system 1400 can additionally perform one or more of the following: solicit opinions for insertion in the opinion aggregation system 1100; communicate requests for new opinion summaries to the text generator 1300; and communicate information about users to the text generator 1300.

In accordance with an exemplary embodiment of the claimed invention, the opinion summarization system 1000 can be configured to produce and return summaries on-demand, or to produce and cache summaries before a request is received the user. It is appreciated that the system operator can configured the opinion summarization system 1000 depending on the desired response time, storage efficiency, and computational efficiency.

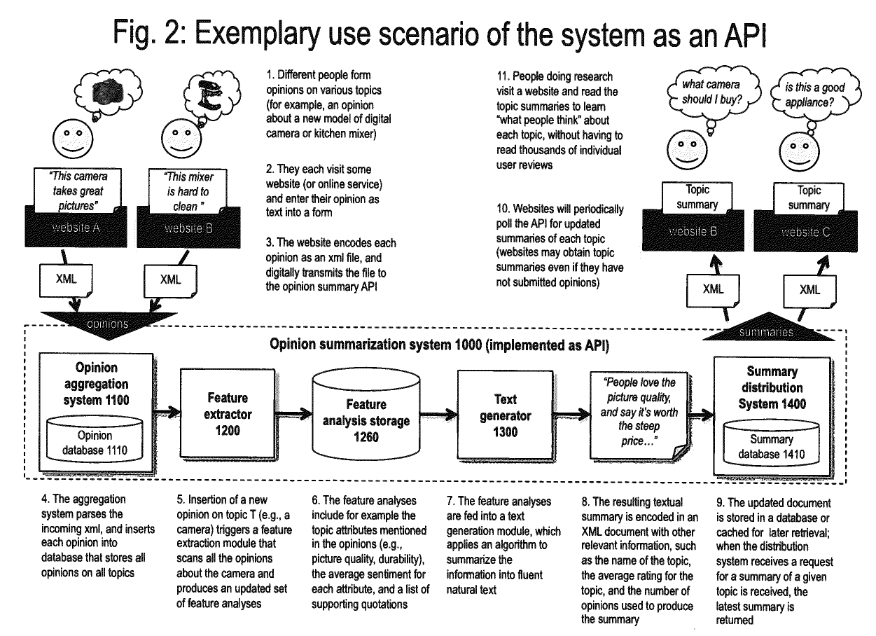

Turning now to FIG. 2, there is illustrated an exemplary use of the opinion summarization or summary system 1000 in accordance with an embodiment of the present invention. The opinion summarization system 1000 of FIG. 2 is implemented as an Internet API (Application Programming Interface) in accordance with an exemplary embodiment of the present invention. Preferably, the API has the following features:
The direct consumers of the API are web sites (or other Internet or electronic services) operated by a third party,
People use the third party web sites either to enter in their opinions on a topic, or to retrieve summaries on a topic; and
The web sites then communicate with the API using HTTP/REST protocol either to transmit opinions into the API (as XML documents), or to retrieve topic summaries from the API (as XML documents).

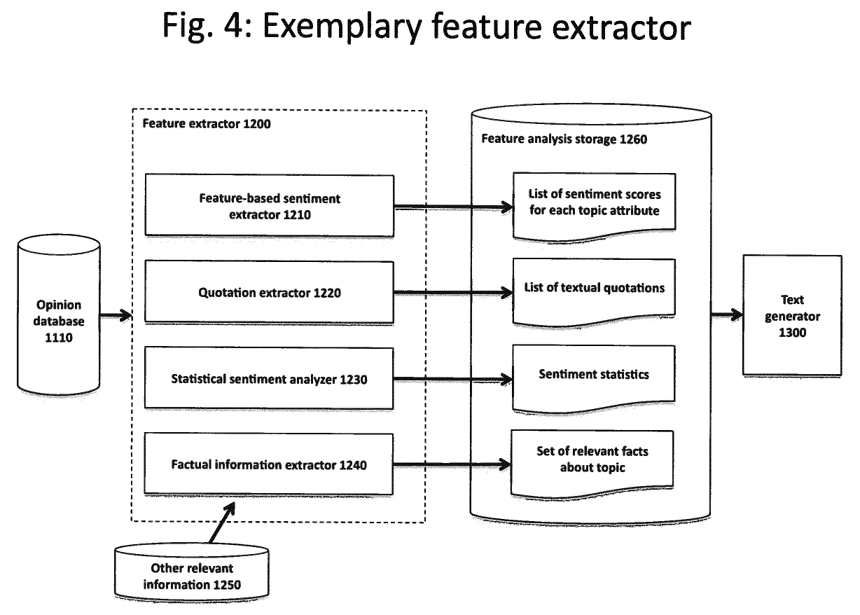

Turning now to FIG. 4, there is illustrated the feature extractor 1200 comprising a plurality of text analytic and/or statistical extractors/analyzers, each extracting specific types of information from the opinion database 1110, and storing the extracted features in the feature analysis storage 1260. It is appreciated that the feature analysis storage 1260 can be a file storage system, a database, a disk storage, removable storage, such as flash drive, memory and the like. In accordance with an embodiment of the claimed invention, the feature extractor 1200 comprises one or more the following exemplary text analytic and/or statistical extractors/analyzers:

A feature based sentiment extractor 1210 comprises an algorithm for extracting feature based sentiment from textual portion of opinions stored in the opinion database 1110 and storing the extracted feature based sentiment in the feature analysis storage 1260.

A quotation extractor 1220 comprises an algorithm for extracting helpful quotations from textual portion of opinions stored in the opinion database 1110, such as by filtering for opinions that were voted as helpful, and then filtering the titles of those opinions for suitable length and/or grammatical syntax, and storing the extracted textual quotations in the feature analysis storage 1260.

A statistical sentiment analyzer 1230 comprises an algorithm for extracting statistics on overall sentiment, including average sentiment, distribution of sentiment from positive to negative, change in sentiment over time. This information can be obtained by taking statistics on the number of opinions, the date of each opinion, and the overall rating associated with each opinion. In cases where an opinion was not entered with an overall rating, the sentiment polarity can be estimated using standard text/sentiment classification techniques, such as a trained Naïve Bayes Classifier. The statistical sentiment analyzer 1230 stores the extracted sentiment statistics in the feature analysis storage 1260.

A factual information extractor 1240 comprises an algorithm for producing descriptive information on the topic obtained from the other relevant information database 1250, including topic name, history, and/or other factual details. That is, the factual information extractor 1240 obtains this descriptive information of topic information from the other relevant information database 1250 rather than extracting it from the opinion text itself. The factual information extractor 1240 stores the extracted set of relevant facts in the feature analysis storage 1260.

In accordance with an exemplary embodiment of the claimed invention, the feature extractor 1200 produces set of feature analyses by combining outputs from a plurality of text analytic and/or statistical extractors/analyzers utilizing various feature extraction algorithms. The following is an exemplary list of various text analytic and/or statistical extractors/analyzers of the feature extractor 1200:

The feature based sentiment extractor 1210 generates a list of topic attributes with a sentiment score and sample size associated with each attribute. The list of extracted attributes depends on the topic area being summarized. For example, if the topic is a digital camera product, then exemplary attributes can include picture quality, battery life, size, price, durability, etc. If the topic is a hotel service, then exemplary attributes can include room size, cleanliness, location, price, service, amenities, etc. In accordance with exemplary embodiment of the claimed invention, each attribute has a sentiment score, represented as a floating point number ranging from −1 to 1, where −1 reflects negative sentiment and 1 reflects positive sentiment. Each attribute also has a sample size, reflecting the number of relevant opinions from the opinion database that commented on that attribute/topic combination.

The quotation extractor 1220 generates a list of textual quotations drawn from the opinions. Each quotation can be tagged by the content of the phrase. For example, descriptive quotations (describing the topic, or attributes of the topic), evaluative quotations (expressing a judgment on the topic, or attributes of the topic), feature-oriented adjectives (adjectives used to describe attributes of the topic), and other feature-oriented descriptive quotations (describing attributes of the topic). Each quotation may also be tagged by grammatical type. For example, “singular noun phrase,” “plural noun phrase,” “verb phrase,” etc.

The statistical sentiment analyzer 1230 generates overall sentiment statistics, including total number of opinions, whether sentiment has been trending up or down, and an overall −1 to 1 rating for the topic.

The factual information extractor 1240 generates a set of relevant background facts about the topic. Exemplary facts can include: name of the topic; details on the opinions used to prepare the opinion summary (e.g., the number of opinions, the sources they were drawn from, names of authors, etc); and specific facts relevant to the topic area For example, if the topic is a type of digital camera, relevant facts can include average retail price, number of megapixels, manufacturer, date that the product was released, etc.

In accordance with an exemplary embodiment of the claimed invention, the feature based sentiment extractor 1210 analyzes opinion from the opinion database 1110 on a given topic X, and outputs a list of attributes (relevant to X) with a sentiment score and sample size associated with each attribute. It is appreciated that this can be accomplished in a variety of ways, using advanced techniques for text/sentiment analysis and machine learning. The feature set produced by the feature based sentiment extractor 1210 can either be known ahead time, or it may be learned as part of the analysis process. The feature set can be either generic, or specially tuned to the topic area under analysis.

In accordance with an embodiment of the claimed invention, the feature based sentiment extractor 1210 comprises the following exemplary algorithm in pseudocode to compute a feature-based sentiment analysis for topic X. For simplicity, the exemplary algorithm uses a known feature set for topic X, but variants are possible in which the feature set is not known ahead of time.

Exemplary Inputs:

A selected subset of opinions O from the opinion database 1110 that are about topic X.

A relevant feature set FS: i.e., an ordered list of length m of known features F₁ . . . Fₘ that may be discussed in the opinions; for each feature in the list a set of corresponding text phrases used to detect the feature, and a default sentiment integer (either −1, 0, or 1, where −1 indicates negative sentiment, 0 indicates neutral sentiment, and 1 indicates positive sentiment).

A generic list of phrases SP commonly used to express sentiment (e.g., “love”, “hate”, “beautiful”, “terrible”, “so-so”, etc). Each phrase is categorized with a default sentiment integer as above.

A generic list of phrases NP commonly used to express negation (e.g., “not”, “neither”, “nor”).

Exemplary Outputs:

V1, which is a vector of m integers (where m is the number of features in FS) that represents the net sentiment (from −1 to 1) for each feature in FS; and

S, which is a vector of m integers that represents the number of opinions that expressed a positive or negative sentiment for each feature in FS.

The following is an exemplary algorithm in pseudocode to compute a feature-based sentiment analysis for topic X:

```
define function feature_based_sentiment_analysis(O,FS,SP,NP):
    // Create a global variable to track net sentiment for each feature
    in FS
    V1 = a vector of m numbers each initialized to 0
    // Create a variable to sample size for each feature in FS
    S = a vector of m numbers each initialized to 0
    for each opinion o in the input set do
        // Create a local variable to track net sentiment for each
    feature in FS
        V2 = a vector of m integers each initialized to 0
        T = a vector of n text tokens derived from o, after extracting
        the textual content of o, and perform phrase tokenization,
        stemming and stopword removal (using standard text processing
        techniques)
        // Iterate through tokens and look for feature terms
        for each integer i between 1 and n do
            if T[i] is a term in FS:
                s = default sentiment integer for feature term
                T[i]
                // Look for nearby sentiment terms
                for j in [−2,−1,1,2] do
                    if i+j >= 1 and i+j <= n and T[j] is a term
                    in SP then
                        s = default sentiment of the term
                        T[j]
                        break out of nearest loop
                    end if
                end for
                // Look for nearby negation words
                for j in [−2,−1,1,2] do
                    if i+j >= 1 and i+j <= n and T[j] is a
                    negation word then
                        s = s * −1
                        break out of nearest loop
                    end if
                end for
                V2[j] = V2[j] + s, where j is the index for
                feature term T[i]
            end if
        end for
        // Transfer information in V2 to V1
        for each integer i between 1 and m do
            if V2[i] > 0 then
                V1[i] = V1[i] + 1
                S[i] = S[i] + 1
            end if
            if V2[i] < 0 then
                V1[i] = V1[i]
                S[i] = S[i] + 1
            end if
        end for
    end for
    // Normalize data in V1 into a −1 to 1 scale
    for each integer i between 1 and m do
        if V1[i] != 0 then
            V1[i] = V1[i] / S[i]
        end if
    end for
    return V1 and S
```

It is appreciated that the feature based sentiment extractor 1210 can utilize other suitable sentiment analysis systems and methods.

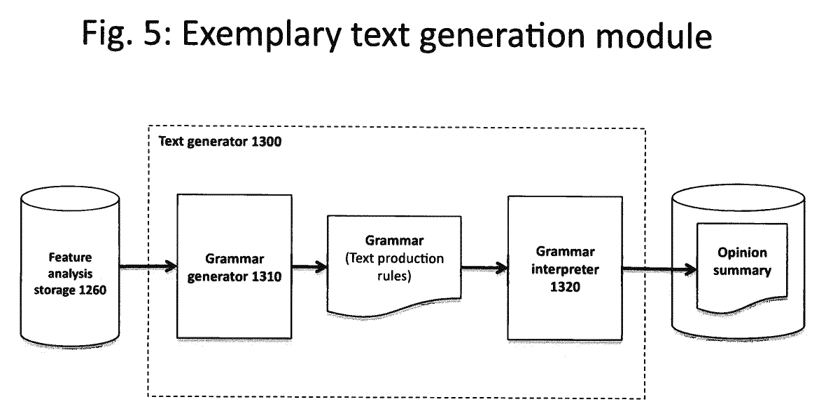

Turning now to FIG. 5, in accordance with an embodiment of the claimed invention, there is illustrated an exemplary text generator 1300. The text generator 1300 comprises a grammar generator 1310 and a grammar interpreter 1320. The grammar generator 1310 translates the set of feature analysis received from the feature extractor 1200 into a set of text production rules that collectively define a generative grammar. The rules are then fed into a specialized grammar interpreter 1320, which evaluates the rules into a particular textual output (along with markup tags, annotations, and other associated information to complement the text). It is appreciated that a myriad of potential texts can often be produced from the same set of production rules. Accordingly, the claimed invention utilizes a novel form of generative grammar called a Pluribo context-free grammar (PCFG), described shortly described herein.

In order to meet the text generation criteria of relevance, fluency, variety and robustness, in accordance with an embodiment of the claimed invention, the exemplary text generator 1300 is based on a type of generative grammar, known as a context-free grammar (CFG). The claimed text generator 1300 extends standard CFGs in several novel ways. Alternative implementations of the text generator 13.00 can also be based on other types of generative text systems, such as probabilistic content-free grammars, or context-sensitive grammars. A Context Free Grammar is a class of generative grammar in which every production rule is of the form V→w, where V is a single nonterminal symbol, and w is a sequence of terminals and/or nonterminals (the sequence may be empty). A terminal is a string (such as “hello”). When a terminal T occurs on the right-hand side (RHS) of a production rule, a grammar interpreter 1320 evaluates T by outputting its corresponding string.

A nonterminal is a symbol (such as A or B). When a nonterminal N occurs on the RHS of a production rule, a grammar interpreter 1320 evaluates N by finding another production rule R that has N on its left-hand side (LHS). R's RHS is then evaluated.

For example, when evaluated with beginning with S, the following rules of the text generator 1300 can produce the text “hello world”:

S → A B
A → “hello ”
B → “world”

By placing a disjunction symbol “|” in the left hand side of S, S can generate either the nonterminal A, or the nonterminal B. To resolve a disjunction, the grammar interpreter 1320 can choose one of the disjuncts randomly. For example, the following rules of the text generator 1300 can sometimes produce the text “hello” and sometimes produce the text “world”:

S → A | B
A → “hello”
B → “world”

An extension to CFGs allows non-terminals to take a parameter. A production rule for a parameterized non-terminal is of the form V(x)→w, where x is a parameter for a terminal, and w is a string of nonterminals and/or terminals that has at least one occurrence of x. For example, the following rules of the text generator 1300 use parameterization. When evaluated, the grammar interpreter 1320 produces the string “hello world:

S → A(“hello”)
A(x) → x “ world”

CFGs provide a useful framework for converting data into fluent text. For example, suppose the top 3 features that people liked about a certain digital camera were “compact size,” “picture quality,” and “price.” To express this in fluent text, the text generator 1300 begins with a generic production rule S:

S→“People liked the “A”, “B,”, and “C”.”

The text generator 1300 then creates a mapping to translate the top 3 features (whatever they may be) into suitable production rules. For example:

A → “compact size”
B → “picture quality”
C → “price”

When evaluated, this CFG of the text generator 1300 produces the sentence “People liked the compact size, picture quality, and price.”

In accordance with an exemplary embodiment of the claimed invention, the criteria for variety and fluency of the text generator 1300 can be met by the CFGs. A context free grammar with many production rules that have disjunctions on their LHS can produce a variety of outputs. For example, the following rules can generate 81 different sentences, which all express the same basic idea/proposition:

S → A B C “that they “ D “this digital camera.”
A → “Many ” | “Lots of “ | “Numerous ”
B → “people “ | “folks “ | “users “
C → “said “ | “commented “ | “remarked ”
D → “liked “ | “were satisfied “ | “were pleased with”

Exemplary outputs of the text generator 1300 when this CFG is evaluated include: “Many people said that they liked this digital camera.” and “Lots of users remarked that they were pleased with this digital camera” Additionally, this example also shows that a well-constructed CFG can produce fluent text output.

However, these basic CFGs do not necessary address the criteria of relevancy and robustness of the text generator 1300. The exemplary text generator 1300 of the claimed invention meets these criteria through a combination of production rules that are included in the grammar for a given topic and a pair of novel extensions to the CFGs. In accordance exemplary embodiment of the present invention, the text generator 1300 comprises a set of production rules providing grammar for generating text for any given topic X. The exemplary text generator 1300 of the claimed invention can generate production rules in two ways: generation of production rules from feature analyses and generic production rules. For each data structure contained in the set of feature analyses, the grammar generator 1310 utilizes a fixed mapping to convert the data in this type of structure into a production rule. For example, the grammar generator 1310 can convert the output of the feature-based sentiment extractor 1210 into production rules using a mapping principle such as by sorting the list of m features in order of descending sentiment. For 1 . . . m, the grammar generator 1310 outputs a corresponding production rule for each feature in the list:

F1 → <feature 1>
F2 → <feature 1>
...
Fm → <feature 1>

In accordance with an exemplary embodiment of the claimed invention, the grammar generator 1310 translates all the information in the feature analyses into production rules using similar fixed mapping principles.

While the feature analyses combined with the mapping principles can dynamically generate production rules suitable for any topic, these production rules can be supplemented by generic production rules. For example:

S→“People commented most favorably on features “F” and “F2”.”

The exemplary grammar generator 1310 of the claimed invention can use a different set of generic production rules for different topic domains (e.g., electronics product opinions, restaurant opinions, etc.). In accordance an exemplary embodiment of the claimed invention, the grammar generator 1310 employs two novel extensions to CFGs: incompleteness and scoring.

The grammar generator 1310 of the claimed invention can vary the set of available features analyses from topic to topic depending on the amount of information available, results of the analyses, and the topic domain. As a result, the production rules generated from the feature analysis varies as well. To be robust, the grammar interpreter 1320 produces text output even when the topic grammar is incomplete (that is, when certain nonterminals in the topic grammar fail to have corresponding production rules). The basic CFGs are complete such that every nonterminal N has a corresponding production rule with N on the LHS. In accordance with an exemplary embodiment of the claimed invention, the exemplary text generator 1300 allows incomplete CFGs. The grammar interpreter 1320 computes all possible sentences that can be derived from the grammar, and ignores any sentence for which there is an unmatched nonterminal.

Some production rules in the topic grammar can be more specific and informative than others. Ideally, to produce relevant text, the grammar interpreter 1320 should always produce the most informative sentences from all available possibilities. Basic CFG production rules contain no mechanism to do this; when a basic CFG grammar interpreter encounters a production rule with a disjunction, the interpreter simply chooses a disjunct at random. In accordance with an exemplary embodiment of the claimed invention, the text generator 1300 employs scoring, which is a novel CFG extension, to increase the relevancy of the text produced from CFGs. In the text generator 1300 of the exemplary system, each terminal is associated with a point value, where the point value must be an integer zero or higher.

When the CFG is evaluated, the grammar interpreter 1320 of the claimed invention uses the point values in two ways: (1) ignore any production rule that contains a non-terminal with a point value of zero; (2) compute all possible sentences that can be generated with the given grammar, find the set of sentences that have the highest combined point value, and return a sentence at random from among this set. The point value is denoted in a production rule in square parentheses after each terminal, as follows:

S → “People liked “[1] A | “People liked “[1] A “ because “[1] B
A →“the digital camera”
B →“of its low price”

In this example, the second disjunct in S is more informative and is associated with a higher point value, thus the grammar interpreter 1320 outputs the sentence: “People like the digital camera because of its low price.” In accordance with an exemplary embodiment of the claimed invention, the text generator 1300 combines scoring with incompleteness to provide a powerful combination. For example, suppose that there is insufficient data to produce a production rule such as B in the above example and that this production rule is omitted. The topic grammar now contains only the rules:

S → “People liked “[1] A | “People liked “[1] A “ because “[1] B
A →“the digital camera”

In such a case, the grammar interpreter 1320 produces and outputs the following sentence as having the highest point value: “People liked the digital camera.” In accordance with an exemplary embodiment of the claimed invention, the Pluribo or extended CFG has these novel extensions for incompleteness and scoring and the Pluribo CFG or grammar interpreter 1320 can evaluate the Pluribo or extended CFG.

In accordance with an exemplary embodiment of the claimed invention, the grammar generator 1310 produces a topic grammar for any topic X using the method for generating appropriate production rules as described herein. The topic grammar consists of production rules from two sources:

Production rules derived by translating data from the set of feature analyses into a Pluribo or extended CFG using mapping principles as described herein.

Generic production rules, as described herein, suitable for all topic domains or for that specific topic domain. The generic production rules contain many different syntactic formulations for expressing summaries in text form, as well as appropriate synonyms for expressing similar concepts in different ways. The grammar is a Pluribo or extended CFG, as described herein.

The text generator 1300 receives a Pluribo or extended CFG as an input and outputs an “opinion summary” or a string of fluent text along with related markup tags and information. In accordance with an exemplary embodiment of the claimed invention, the grammar interpreter 1320 is implemented as a Pluribo or extended CFG interpreter, as described herein. The Pluribo or extended CFGs as described herein are sufficient to prepare fluent text, as well as to insert appropriate markup tags (e.g., tags surrounding feature terms) and annotations in the text (e.g., an XML list of source opinions used to prepare the fluent text). The output of the grammar interpreter 1320 can also be supplemented with other background information for inclusion in the opinion summary.

In accordance with an exemplary embodiment of the present invention, the text generator 1300 generates an opinion or textual summary of a topic comprising multiple lines of well-formed natural language text and can optionally include machine readable tag annotations. The tag annotations facilitate appropriate automatic formatting of the text (e.g., insertion of internet hyperlinks, or html formatting code) when the textual summary is displayed. Such tag annotations are produced from the grammar itself, in the same way as the summary, and as such these annotations can be enriched, modified, or omitted by making appropriate changes to the grammar.

The following is an exemplary fluent textual summary for topic #AZB000Q3043Y that was produced from the text generator 1300:

A number of users were excited about the <tag name=“price”
kind=“opinion” topic-id=“AZB000Q3043Y”>value for the
money</tag> and <tag name=“ease” kind=“opinion”
topic-id=“AZB000Q3043Y”>ease of use</tag>. Others complained
about the <tag name=“reliability” kind=“opinion” topic-
id=“AZB000Q3043Y”>reliability</tag> and <tag name=“weight”
kind=“opinion” topic-id=“AZB000Q3043Y”>weight</tag>.
One person remarked, “Loaded with features, but don't expect
amazing results”.

The following is above text with tags omitted:

A number of users were excited about the value for the money and
ease of use. Others complained about reliability and weight. One
person remarked, “Loaded with features, but don't expect
amazing results”.

In accordance with an exemplary embodiment of the claimed invention, the text generator 1300 can generate and the distribution system 1400 can distribute the fluent textual summary along with other supplementary information, including but not limited to:

The title and model information of the item being evaluated;

The number of opinions used to generate the opinion summary;

The date the opinion summary was produced;

A numeric rating for the item;

The sources of the opinions used to generate the opinion summary; and

The raw text of the opinions used to generate the opinion summary.

In accordance with an exemplary embodiment of the claimed invention, the computer based method for automatically generating fluent textual summary from multiple opinions comprises the steps of retrieving textual opinions, generating opinion summary and storing the opinion summary. The textual opinions relevant to a predetermined topic are retrieved from the opinion database and analyzed by extracting a plurality of predetermined features from the retrieved textual opinions, which are stored in a feature analysis storage. An opinion summary is generated that summarizes all of the retrieved textual opinions relevant to the predetermined topic by converting the plurality of predetermined features extracted from the retrieved textual opinions. The opinion summary comprises a fluent block of text and is stored in the opinion summary.

In accordance with an exemplary embodiment of the claimed invention, the computer readable medium comprises code for automatically generating a fluent textual summary from multiple opinions. The code comprises computer executable instructions for retrieving textual opinions, generating opinion summary and storing the opinion summary. The textual opinions relevant to a predetermined topic are retrieved from the opinion database and analyzed by extracting a plurality of predetermined features from the retrieved textual opinions, which are stored in a feature analysis storage. An opinion summary is generated that summarizes all of the retrieved textual opinions relevant to the predetermined topic by converting the plurality of predetermined features extracted from the retrieved textual opinions. The opinion summary comprises a fluent block of text and is stored in the opinion summary. It is appreciated that the computer readable medium is a tangible storage device for storing computer executable instructions, such as memory, CD, DVD, flash drive and the like.

In accordance with an exemplary embodiment of the claimed invention, the following is an exemplary representation of a textual summary combined with other supplementary information; this is a sample output of the opinion summarization system 1000 of the claimed invention, encoded as XML and suitable for electronic distribution, storage, and/or further processing.

<?xml version=“1.0” ?>
<response><summary><body-tagged>A number of users were excited about the
<tag name=“price” kind=“opinion” topic-id=“AZB000Q3043Y”>value for the
money</tag> and <tag name=“ease” kind=“opinion” topic-id=“AZB000Q3043Y”>ease
of use</tag>. Others complained about the <tag name=“reliability”
kind=“opinion” topic-id=“AZB000Q3043Y”>reliability</tag> and <tag
name=“weight” kind=“opinion” topic-id=“AZB000Q3043Y”>weight</tag>. One
person remarked , “Loaded with features, but don't expect amazing
results”.</body-
tagged><topic><manufacturer>Canon</manufacturer><upc>013803079616</upc><domain>
products</domain><name>Canon PowerShot Pro Series S5 IS 8.0MP Digital
Camera with 12x Optical Image Stabilized
Zoom</name><ean>0013803079616</ean><asin>B000Q3043Y</asin><model>2077B001</model>
<id>AZB000Q3043Y</id></topic><opinion-count>256</opinion-
count><rating>7.9</rating><timestamp>2008-03-
31T16:35:09.560737</timestamp><body>A number of users were excited about the
value for the money and ease of use. Others complained about the reliability
and weight. One person remarked , &quot;Loaded with features, but don't
expect amazing results&quot;.</body><trend>0.0</trend></summary></response>

The following is an exemplary Pluribo or extended CFG grammar in accordance with an embodiment of the claimed invention. It is appreciated that there are many ways to enrich the Pluribo or extended CFG grammar. When this grammar is interpreted by the CFG or grammar interpreter 1320, the text generator 1300 of the claimed invention can produce or generate the summarized output or “opinion summary” as shown herein. It is appreciated that lines beginning with “##” are comments (and are ignored by the grammar interpreter 1320) and each grammar rule begins with “RuleName.”

```
## Basic structure - generic
start = Sentence;
Sentence = FeatureAnalysis ‘ ’[1] Quote | FeatureAnalysis | IntroFact
    FeatureAnalysis ‘ ’[2] Quote | IntroFact;
## Automatically generated grammar resulting from feature-based sentiment
    analysis, quote analysis, and rating on a specific item (non-generic)
FeatureAnalysis = ProsConsOrder;
ProFeature1PosSing = ‘<tag name=“price” kind=“opinion” topic-
    id=“AZB000Q3043Y”>low price</tag>’[3] | ‘<tag name=“price” kind=“opinion”
    topic-id=“AZB000Q3043Y”>bang for the buck</tag>’[3] | ‘<tag name=“price”
    kind=“opinion” topic-id=“AZB000Q3043Y”>value for the money</tag>’[3];
ProFeature1GenSing = ‘<tag name=“price” kind=“opinion” topic-
    id=“AZB000Q3043Y”>price</tag>’[2] | ‘<tag name=“price” kind=“opinion” topic-
    id=“AZB000Q3043Y”>pricing</tag>’[2];
ProFeature2PosSing = ‘<tag name=“ease” kind=“opinion” topic-
    id=“AZB000Q3043Y”>ease of use</tag>’[3];
ConFeature1NegSing = ‘<tag name=“reliability” kind=“opinion” topic-
    id=“AZB000Q3043Y”>reliability</tag>’[2] | ‘<tag name=“reliability”
    kind=“opinion” topic-id=“AZB000Q3043Y”>reliability</tag>’[2] | ‘<tag
    name=“reliability” kind=“opinion” topic-id=“AZB000Q3043Y”>lack of
    reliability</tag>’[2];
ConFeature1GenSing = ‘<tag name=“reliability” kind=“opinion” topic-
    id=“AZB000Q3043Y”>reliability</tag>’[2];
ConFeature2GenSing = ‘<tag name=“weight” kind=“opinion” topic-
    id=“AZB000Q3043Y”>weight</tag>’[2];
TopQuote = ‘Loaded with features, but don\hat{ }t expect amazing results’[0];
ScoreNum = ‘79’[0];
## Intro grammar - generic
IntroFact = RisingNewProduct ‘’[2] | EstimatedNew ‘’[1] NewProductText |
    TrendingUp RisingText | TrendingDown FallingText | HighBuzz BuzzText |
    Disagreement ‘’[1] DisagreementText;
RisingNewProduct = EstimatedNew TrendingUp ‘’[3] RisingNewProductText;
RisingNewProductText = ‘Just released, this product has been rising in the
    ratings. ’ | ‘This new product has been gaining attention. ’ | ‘Recently
    released, this item has been moving up in the rankings. ’;
NewProductText = ‘A new release. ’ | ‘A recent release. ’ | ‘This product has
    just been released. ’ | ‘New on the market. ’;
RisingText = ‘This item has been rising in the rankings. ’ | ‘This product has
    been moving up in the rankings. ’ | ‘This item moving up in the ratings. ’;
FallingText = ‘This product has been slipping in the rankings. ’ | ‘This item has
    been falling in the rankings. ’ | ‘This product has been losing ground in
    the rankings. ’ | ‘The rating for this product has fallen recently. ’;
BuzzText = ‘This item has been getting a lot of attention. ’ | ‘This product has
    been the focus of many reviews. ’ | ‘Many people have spoken out on this
    item. ’;
DisagreementText = ‘Opinion is divided on this item. ’ | ‘People disagree over
    this item. ’ | ‘Opinions vary widely on this item. ’;
## Quote grammar - generic
Quote = WrappedQuote | QuotePrefix WrappedQuote | QuotePrefix WrappedQuote;
WrappedQuote = QuoteMarks( TopQuote ) ‘.’[0] ;
QuoteMarks(arg) = ‘“’ arg ‘”’;
UserTerm = ‘user ’ | ‘person ’ | ‘reviewer ’;
SaidTerm = ‘said ’ | ‘remarked ’ | ‘commented ’ | ‘noted ’ | ‘wrote ’;
QuotePrefix = ‘One ’ UserTerm SaidTerm ‘, ’ | ‘According to one ’ UserTerm ‘, ’ ;
## Feature analysis grammar - generic
FeatureAnalysis = ProsOrder | ConsOrder | DiscussedOrder | ProsConsOrder |
    ProsDiscussedOrder |
                    ConsProsOrder | ConsDiscussedOrder |
    DiscussedProsOrder | DiscussedConsOrder ;
UserNounUpper = ‘People ’ | ‘Users ’;
UserNounLower = ‘people ’ | ‘users ’;
CommentedTerm = ‘commented on ’ | ‘remarked on ’ | ‘mentioned ’ | ‘said ’;
CommentedPresTerm = ‘say ’ | ‘comment ’ | ‘remark ’ | ‘mention ’;
ConcernsTerm = ‘concerns over ’ | ‘concerns with ’ | ‘issues with ’;
GoodTerm = ‘great ’ | ‘good ’;
BadTerm = ‘great ’ | ‘good ’;
ManyTermUpper = ‘Many ’ | ‘Some ’ | ‘Many ’ | ‘Some ’ | ‘A number of ’;
TheyLikedTerm = ‘liked ’ | ‘were pleased with ’ | ‘were satisfied with ’ | ‘were
    happy with ’ | ‘were positive about ’ | ‘were excited about ’ | ‘praised ’;
ProVerbPhrase = TheyLikedTerm ‘the ’ ProFeatureList;
TheyDislikedTerm = ‘complained about ’ | ‘weren't pleased with ’ | ‘griped about ’
    | ‘weren't so pleased with ’ | ‘had issues with ’ | ‘criticised ’ | ‘were
    critical about ’ | ‘warned about ’ | ‘were concerned over ’ | ‘were
    concerned with ’;
ConVerbPhrase = TheyDislikedTerm ‘the ’ ConFeatureList ;
ProsConsOrder = ProsCons | ProsCons ‘ ’[2] ProComment | ProsCons ‘ ’[1]
    ConComment ;
ProsCons = UserNounUpper ProVerbPhrase ‘, but ’ ConVerbPhrase ‘.’ | UserNounUpper
    ProVerbPhrase ‘, but some ’ ConVerbPhrase ‘.’ | ManyTermUpper UserNounLower
    ProVerbPhrase ‘, while some ’ ConVerbPhrase ‘.’ | ManyTermUpper
    UserNounLower ProVerbPhrase ‘. Others ’ ConVerbPhrase ‘.’ | UserNounUpper
    CommentedTerm GoodTerm ProFeatureSingList ‘, but some ’ ConVerbPhrase ‘.’ |
    ManyTermUpper UserNounLower CommentedTerm GoodTerm ProFeatureSingList ‘,
    while other ’ UserNounLower ConVerbPhrase ‘.’ | ManyTermUpper UserNounLower
    CommentedTerm GoodTerm ProFeatureSingList ‘, while others ’ ConVerbPhrase
    ‘.’ | ‘According to ’ UserNounLower ‘the pros are the ’ ProFeatureList ‘.
    The cons are ’ ConcernsTerm ConFeatureSingList ‘.’ | ‘The most frequently
    mentioned pros are ’ ProFeatureSingList ‘. The most frequently mentioned
    cons are ’ ConcernsTerm ConFeatureSingList | ‘The ’ ProFeatureList ‘ were
    the most frequently mentioned pros, while some ’ UserNounLower ConVerbPhrase
    ‘.’ | ‘The ’ ProFeatureList ‘ were the most commonly mentioned pros. Cons
    include ’ ConFeatureList ‘.’ | ‘Commonly mentioned pros include ’
    ProFeatureList ‘, while some ’ ConVerbPhrase ‘.’ ;
ProComment = ManyTermUpper UserNounLower CommentedPresTerm ProComment1 ‘.’ |
    ManyTermUpper UserNounLower CommentedPresTerm ProComment1 ‘ and ’
    ProComment2 ‘.’;
ConComment = ManyTermUpper UserNounLower CommentedPresTerm ConComment1 ‘.’ |
    ManyTermUpper UserNounLower CommentedPresTerm ConComment1 ‘ and ’
    ConComment2 ‘.’;
ProFeatureList = ProFeature1 | ProFeature1 ‘ and ’ ProFeature2;
ProFeatureSingList = ProFeature1GenSing | ProFeature1GenSing ‘ and ’
    ProFeature2GenSing;
ProFeature1 = ProFeature1PosSing | ProFeature1GenSing;
ProFeature2 = ProFeature2PosSing | ProFeature2GenSing;
ProFeature3 = ProFeature3PosSing | ProFeature3GenSing;
ConFeatureList = ConFeature1 | ConFeature1 ‘ and ’ ConFeature2 | ConFeature1 ‘, ’
    ConFeature2 ‘, and ’ ConFeature3;
ConFeatureSingList = ConFeature1GenSing | ConFeature1GenSing ‘ and ’
    ConFeature2GenSing | ConFeature1GenSing ‘, ’ ConFeature2GenSing ‘, and ’
    ConFeature3GenSing ;
ConFeature1 = ConFeature1NegSing | ConFeature1GenSing;
ConFeature2 = ConFeature2NegSing | ConFeature2GenSing;
ConFeature3 = ConFeature3NegSing | ConFeature3GenSing;
```

In accordance with an exemplary embodiment of the claimed invention, the text generator 1300 comprises a Pluribo or extended grammar parser or grammar generator 1310 and a grammar interpreter 1320. The following is an exemplary working source code in the python programming language which implements a function that evaluates a scripted Pluribo CFG (PCFG) and probabilistically outputs a string of text:

```
“““
Pluribo Text Generation Class
DESCRIPTION:
Implements classes that read in scripted Pluribo CGF grammar, parses, and outputs
text.
USAGE:
import text_generation
text_output = TextMachine(input_grammar).to_str( )
”””
import random
## Core generative grammar classes
class Symbol:
    def is_terminal(self):
    if self._class_._name_{—} == ‘Terminal’:
            return True
        return False
    def is_nonterminal(self):
        if self._class_._name_{—} == ‘Nonterminal’:
            return True
        return False
    def is_variable(self):
        if self._class_._name_{—} == ‘Variable’:
            return True
        return False
    def _repr_(self):
        return self.lhs
class Terminal(Symbol):
    def _init_(self,lhs_string,rhs_string,score,allow_duplicates=False):
        assert( isinstance(lhs_string,unicode) and
                isinstance(rhs_string,unicode) and
                isinstance(score,int))
        self.lhs = lhs_string
        self.rhs_string = rhs_string
        self.score = score
        self.allow_duplicates = allow_duplicates
class Nonterminal(Symbol):
    def
_init_(self,lhs_string,rhs_lists,param_names=[ ],allow_duplicates=False):
        assert( isinstance(lhs_string,unicode) and
                isinstance(rhs_lists,list) and [len(x) >= 1 for x in
rhs_lists] and
                isinstance(rhs_lists,list))
        self.lhs = lhs_string
        self.rhs_lists = rhs_lists
        self.rhs_terminal_lists = None # used to dynamically compute scores
        self.allow_duplicates = allow_duplicates
        self.num_params = len(param_names)
        self.param_lookup = { }
        for i in range(self.num_params):
            self.param_lookup[param_names[i]] = i
class Variable(Symbol):
    ‘‘‘Global variable. If var is not set, evaluate input and set var to the
result, returning it; else return the present value of var.’’’
    def _init_(self,lhs):
        self.lhs = lhs
        self.rhs_string = None
        self.score = None
## TODO:implement remove duplicates functionality -- may need to return (Score,
text, [SymbolsUsed]) in order to track which symbols to put on the
excluded_symbols list
class GrammarInterpreter(object):
    start_lhs = u‘start’
    def _init_(self,symbols,rnd_seed):
        random.seed(rnd_seed)
        self.symbol_lookup = { }
        self.excluded_symbols = [ ]
        for s in symbols:
            assert(isinstance(s,Symbol))
            self.symbol_lookup[s.lhs] = s
        assert(self.start_lhs in self.symbol_lookup)
    def make_text(self):
        start = self.lookup_symbol(self.start_lhs)
        return self.evaluate_symbol(start)
    def lookup_symbol(self,lhs,bound_params={ }):
        ‘‘‘Take lhs (a string) and dictionary of bound parameters. Returns
Symbol corresponding to lhs, first by checking in bound_params, and then by
checking in self.symbol_lookup.’’’
        if lhs in bound_params:
            return bound_params[lhs]
        if lhs in self.symbol_lookup and lhs not in self.excluded_symbols:
            return self.symbol_lookup[lhs]
        else:
            return None
    def evaluate_terminal(self,symbol):
        ‘‘‘Evaluate the (score,text) tuple associate with this terminal
symbol.’’’
        assert(symbol.is_terminal( ))
        return (symbol.score,symbol.rhs_string)
    def evaluate_variable(self,symbol,value_tuple=None):
        ‘‘‘Evaluate the (score,text) tuple associate with this variable
symbol. If (score,value) tuple is provided, then this become value of variable if
variable is unbound’’’
        assert(symbol.is_variable( ))
        assert(value_tuple == None or len(value_tuple) == 2)
        if ((symbol.score == None or symbol.rhs_string == None) and
            value_tuple != None):
            symbol.score = value_tuple[0]
            symbol.rhs_string = value_tuple[1]
        return (symbol.score,symbol.rhs_string)
    def evaluate_nonterminal(self,symbol,unbound_params = [ ]):
        ‘‘‘Recurively evaluate the (score,text) tuple associate with this
nonterminal symbol.’’’
        assert(symbol.is_nonterminal( ))
        assert(len(unbound_params) == symbol.num_params)
        # recursively evaluate rhss
        max_score = None
        max_values = [ ]
        # try to bind the params -- e.g., associate param names with
terminals tied to (score,value) pairs
        try:
            bound_params = { }
            for key in symbol.param_lookup:
                param = unbound_params[symbol.param_lookup[key]]
                bound_params[key] = Terminal(key,param[1],param[0])
        except:
            return (None,None)
        # evaluate rhs lists
        for rhs in symbol.rhs_lists:
            score,value = self.evaluate_rhs_list(rhs,bound_params)
            if score > max_score:
                max_score = score
                max_values = [value]
            elif score != None and score == max_score:
                max_values.append(value)
        # Return one of the high scorers at random
        if len(max_values) == 0:
            return (None,None)
        else:
            return (max_score,random.choice(max_values))
    def evaluate_symbol(self,symbol,unbound_params = [ ]):
        if not symbol:
            score,value = None,None
        elif symbol.is_terminal( ):
            score,value = self.evaluate_terminal(symbol)
        elif symbol.is_variable( ):
            if unbound_params:
                score,value =
self.evaluate_variable(symbol,unbound_params[0])
            else:
                score,value = self.evaluate_variable(symbol)
        elif symbol.is_nonterminal( ):
            score,value = self.evaluate_nonterminal(symbol,unbound_params)
        return (score,value)
    def evaluate_rhs_list(self,rhs,bound_params={ }):
        assert(isinstance(rhs,list))
        combined_score = 0
        combined_value = u‘’
        for item in rhs:
            # Extract lhs and parameters
            if isinstance(item,list):
                # list, so lhs is first in list followed by parameters
                lhs = item[0]
                symbol = self.lookup_symbol(lhs,bound_params)
                raw_params = item[1:]
            elif isinstance(item,Terminal):
                # nonterminal, so take symbol directly
                symbol = item
                raw_params = [ ]
            elif isinstance(item,unicode):
                # no list, so item is either must be lhs
                lhs = item
                symbol = self.lookup_symbol(lhs,bound_params)
                raw_params = [ ]
            # Evaluate the params into a (score,value) tuple
            unbound_params = [ ]
            for param in raw_params:
                if isinstance(param,Terminal):
                    # Evaluate symbol and put tuple on
unbound_paramas list
    unbound_params.append(self.evaluate_symbol(param))
                elif isinstance(param,unicode):
                    # Evaluate symbol and put tuple on
unbound_paramas list
                    symbol2 = self.lookup_symbol(param,bound_params)
    unbound_params.append(self.evaluate_symbol(symbol2))
                else:
                    raise ValueError
            # Evaluate symbol
            score,value = self.evaluate_symbol(symbol,unbound_params)
            # Processes score and value
            if score == None:
                # invalid output, so stop evaluation of this branch
                return (None,None)
            else:
                combined_score += score
                combined_value += value
        return (combined_score,combined_value)
class GrammarParser:
    ‘‘‘Class to read a scripted grammar from input text, and return a list of
symbolic rules corresponding to the grammar.’’’
    max_variables = 10 # max number of variables for a nonterminal
    def _init_(self,text):
        self.rules = [ ] # to load parsed symbols
        self.lines = text.split(u‘\n’)
        # Remove comments
        for i in range(len(self.lines)):
            comment = self.lines[i].find(u‘#’)
            if comment > −1:
                self.lines[i] = self.lines[i][:comment]
        self.current_l,self.lookahead_l = 0,0 # line number
        self.i = 0  # index on lookahead line
        self.current_c,self.lookahead_c = None,None
        self.nextChar( )
        self.nextChar( )
        self.current_t,self.lookahead_t = None,None
        self.advance( )
        self.advance( )
    def nextChar(self):
        ‘‘‘Read next character and set the variables: self.lookahead_c,
self.current_c, self.lookahead_l, self.current_l’’’
        self.current_c = self.lookahead_c
        if self.i < len(self.lines[self.lookahead_l]):
            # there are chars left on line
            self.lookahead_c = self.lines[self.lookahead_l][self.i]
            self.i += 1
        elif self.lookahead_l + 1 < len(self.lines):
            # there are lines left
            self.lookahead_l += 1
            self.i = 0
            self.nextChar( )
        else:
            # nothing left
            self.lookahead_c = None
    def advance(self):
        ‘‘‘Advance to next token, and set the variables:
self.lookahead_t,self.current_t’’’
        token = None
        self.current_l = self.lookahead_l
        while self.current_c:
            # match quotation
            if self.current_c == u‘\’’:
                token = self.current_c
                self.nextChar( )
                while self.current_c and self.current_c != u‘\’’:
                    token += self.current_c
                    self.nextChar( )
                if self.current_c == u‘\’’:
                    token += self.current_c
                    self.nextChar( )
                    break
                else:
                    self.error(‘Unterminated string’)
                break
            # match colon,bar,parens,etc (tokenize immediately after
symbol)
            elif self.current_c in
[u‘=’,u‘[’,u‘]’,u‘|’,u‘(’,u‘)’,u‘;’,u‘\hat{ }’]:
                token = self.current_c
                self.nextChar( )
                break
            # match ‘<<’ operator
            elif self.current_c == u‘<’ and self.lookahead_c == u‘<’:
                token = u‘<<’
                self.nextChar( )
                self.nextChar( )
                break
            # match integer
            elif self.current_c.isdigit( ):
                num = u‘’
                while self.current_c.isdigit( ):
                    num += self.current_c
                    self.nextChar( )
                token = int(num)
                break
            # match variable name
            elif self.current_c.isalpha( ):
                token = self.current_c
                self.nextChar( )
                while self.current_c and self.current_c.isalnum( ):
                    token += self.current_c
                    self.nextChar( )
                break
            # ignore anything else
            else:
                self.nextChar( )
        self.current_t = self.lookahead_t
        self.lookahead_t = token
        ##print ‘Token ’, self.current( )
    def current(self):
        ‘‘‘Return current token’’’
        return self.current_t
    def lookahead(self):
        ‘‘‘Return lookahead token’’’
        return self.lookahead_t
    def line(self):
        ‘‘‘Return current line number’’’
        return self.current_l
    def error(self,msg):
        ‘‘‘Raise exception with error msg and current line number’’’
        msg = ‘%s with token %s at line %s’ %
(msg,self.current( ),self.line( ))
        raise ValueError, msg
    def parse(self):
        while self.current( ):
            self.match_nonterminal_rule( )
        return self.rules
## generic matching functions
def match_literal(self,literal):
    ‘‘‘Match given literal, or raise exception’’’
    if self.current( ) == literal:
        self.advance( )
        return True
    self.error(‘Error matching literal %s’ % literal)
def match_variable(self):
    ‘‘‘Match a variable name, and return it.’’’
    if self.current( )[0].isalpha( ) and self.current( ).isalnum( ):
        var = self.current( )
        self.advance( )
        return var
    self.error(‘Error matching variable’)
def match_integer(self):
    ‘‘‘Match integer and return it’’’
    if isinstance(self.current( ),int):
        num = self.current( )
        self.advance( )
        return num
    self.error(‘Error matching integer’)
def match_quotation(self):
    ‘‘‘Match quote marks and return everything in between them’’’
    if self.current( )[0] == u‘\’‘ and self.current( )[−1] == u‘\’’:
        tok = self.current( )[1:−1]
        self.advance( )
        return tok
    self.error(‘Error matching quotation’)
## grammar-specific matching functions
def match_nonterminal_rule(self):
    params = [ ]
    rhs_lists = [ ]
    # get lhs name
    lhs = self.match_variable( )
    # check for optional params
    if self.current( ) == u‘(’:
        self.match_literal(u‘(’)
        while self.current( ) != u‘)’:
            params.append(self.match_variable( ))
            if self.current( ) != u‘)’:
                self.match_literal(u‘,’)
        self.match_literal(u‘)’)
    # equal sign
    self.match_literal(u‘=’)
    # match at least 1 rhs (not including bar)
    rhs_lists.append(self.match_rhs( ))
    # keep matching rhs and bar until none left
    while self.current( ) == u‘|’:
        self.match_literal(u‘|’)
        rhs_lists.append(self.match_rhs( ))
    self.match_literal(u‘;’)
    # Add the nonterminal rule to the symbol list
    nt = Nonterminal(lhs,rhs_lists,params)
    self.rules.append(nt)
    return nt
def match_terminal(self):
    if self.current( )[0] == u‘\’‘ and self.current( )[−1] == u‘\’’:
        # match terminal, including optional score in square brackets
            text = self.match_quotation( ).replace(u‘\hat{ }’,u‘\’’)
            score = 0
            if self.current( ) == u‘[’:
                self.match_literal(u‘[’)
                score = self.match_integer( )
                self.match_literal(u‘]’)
            return Terminal(u‘noname’,text,score)
        self.error(‘Error matching quotation’)
    def match_rhs(self):
        # match lhs and bar, if there is one. don't create new i
        rhs = [ ]
        while self.current( ) not in [u‘;’,u‘|’]:
            ##print ‘RHS %s,%s’ % (self.current( ),self.lookahead( ))
            if self.current( )[0].isalpha( ):
                if self.lookahead( ) == u‘<<’:
                    # variable assignment, so read next variable and
create entity
                    lhs = self.match_variable( )
                    self.match_literal(u‘<<’)
                    if self.current( )[0] == u‘\’’:
                        value = self.match_terminal( )
                    else:
                        value = self.match_variable( )
                        # put unassigned in list
                    self.rules.append(Variable(lhs))
                        # var variable assignment in parens within
nontermimal rhs
                    rhs.append([lhs,value])
                elif self.lookahead( ) == u‘(’:
                    # nonterminal with parameters
                    nonterm_list = [self.match_variable( )]
                    self.match_literal(u‘(’)
                    for i in range(self.max_variables):
                        if self.current( ) == (u‘)’):
                            break
                        if self.current( )[0] == u‘\’’:
    nonterm_list.append(self.match_terminal( ))
                        else:
    nonterm_list.append(self.match_variable( ))
                    self.match_literal(u‘)’)
                    rhs.append(nonterm_list)
                else:
                    # match lhs name for nonterm or variable, so
put string in rhs
                    rhs.append(self.match_variable( ))
            elif self.current( )[0] == u‘\’’:
                # match terminal, including optional score in
square brackets
                terminal = self.match_terminal( )
                ##print ‘%s:%s’ %
(terminal.rhs_string,terminal.score)
                rhs.append(terminal)
            else:
                self.error(‘Error matching rhs token %s’ %
self.current( ))
        return rhs
class TextMachine(object):
    def _init_(grammnar_str):
        parsed_grammar = GrammarParser(grammar_str).parse( )
        self.text = GrammarInterpreter(parsed_grammar).make_text( )[1]
    def to_str( ):
        return self.text
```

The invention, having been described, it will be apparent to those skilled in the art that the same may be varied in many ways without departing from the spirit and scope of the invention. Any and all such modifications are intended to be included within the scope of the following claims.

What is claimed:

1. An opinion summarization system for automatically generating a fluent textual summary from multiple opinions, comprising:
a feature extractor for retrieving textual opinions from an opinion database relevant to a predetermined topic and analyzing retrieved textual opinions relevant to said predetermined topic by extracting a plurality of predetermined features from said retrieved textual opinions;
a feature analysis storage for storing said plurality of predetermined features extracted from said retrieved textual opinions; and
a text generator for generating an opinion summary that summarizes all of said retrieved textual opinions relevant to said predetermined topic by converting said stored plurality of predetermined features extracted from said retrieved textual opinions into said opinion summary comprising a fluent block of text.

2. The opinion summarization system of claim 1, wherein said text generator comprises a grammar generator for generating a set of text production rules for said plurality of predetermined features extracted from said retrieved textual opinions and a grammar interpreter for evaluating said set of text production rules into a fluent block of text.

3. The opinion summarization system of claim 2, wherein said grammar generator generates said set of production rules satisfying text generation criteria of relevancy, fluency, variety and robustness.

4. The opinion summarization system of claim 3, wherein said grammar generator is operable to generate said set production rules as an extended context free grammar satisfying said text generation criteria of relevance, fluency, variety and robustness.

5. The opinion summarization system of claim 1, wherein said feature extractor comprises at least one of the following: a feature based sentiment extractor for generating a list of topic attributes with a sentiment score and sample size associated each topic attribute from said retrieved textual opinions; a quotation extractor for generating a list of textual quotations from said retrieved textual opinions; a statistical sentiment analyzer for generating overall sentiment statistics; and a factual information extractor for generating a set of relevant background facts about said predetermined topic.

6. The opinion summarization system of claim 1, further comprising an opinion aggregation system for aggregating multiple textual opinions on a topic received from a multiple sources over a communications network into said opinion database.

7. The opinion summarization system of claim 6, wherein said opinion aggregation system converts each textual opinion into a standard format and stores formatted opinion in said opinion database.

8. The opinion summarization system of claim 1, further comprising a distribution system for storing said opinion summary in an opinion summary database, and distributing or transmitting said opinion summary to user over a communications network.

9. The opinion summarization system of claim 8, wherein said distribution system is operable to solicit opinions for insertion into said opinion database over said communications network and to receive request for an opinion summary from said user over said communications network.

10. A computer based method for automatically generating a fluent textual summary from multiple opinions, comprising the steps of
retrieving textual opinions from an opinion database relevant to a predetermined topic and analyzing retrieved textual opinions relevant to said predetermined topic by extracting a plurality of predetermined features from said retrieved textual opinions;
storing said plurality of predetermined features extracted from said retrieved textual opinions in a feature analysis storage; and
generating an opinion summary that summarizes all of said retrieved textual opinions relevant to said predetermined topic by converting said plurality of predetermined features extracted from said retrieved textual opinions into said opinion summary comprising a fluent block of text.

11. The method of claim 10, further comprising the steps of generating a set of text production rules for said plurality of predetermined features extracted from said retrieved textual opinions, said set of production rules satisfying text generation criteria of relevancy, fluency, variety and robustness.

12. The method of claim 10, further comprising step of generating at least one of the following: generating a list of topic attributes with a sentiment score and sample size associated each topic attribute from said retrieved textual opinions; generating a list of textual quotations from said retrieved textual opinions; generating overall sentiment statistics; and generating a set of relevant background facts about said predetermined topic.

13. The method of claim 1, further comprising the steps of aggregating multiple textual opinions on a topic received from a multiple sources over a communications network; converting each textual opinion into a standard format; and storing formatted opinion in said opinion database.

14. The method of claim 1, further comprising the steps of distributing or transmitting said opinion summary to user over a communications network; soliciting opinions for insertion into said opinion database over said communications network; and receiving a request for an opinion summary from said user over said communications network.

15. A computer readable medium comprising code for automatically generating a fluent textual summary from multiple opinions, said code comprising computer executable instructions for:
retrieving textual opinions from an opinion database relevant to a predetermined topic and analyzing retrieved textual opinions relevant to said predetermined topic by extracting a plurality of predetermined features from said retrieved textual opinions;
storing said plurality of predetermined features extracted from said retrieved textual opinions in a feature analysis storage; and
generating an opinion summary that summarizes all of said retrieved textual opinions relevant to said predetermined topic by converting said plurality of predetermined features extracted from said retrieved textual opinions into said opinion summary comprising a fluent block of text.

16. The computer readable medium of claim 15, further comprising computer executable instructions for generating a set of text production rules for said plurality of predetermined features extracted from said retrieved textual opinions, said set of production rules satisfying text generation criteria of relevancy, fluency, variety and robustness.

17. The computer readable medium of claim 15, further comprising computer executable instructions for generating at least one of the following: generating a list of topic attributes with a sentiment score and sample size associated each topic attribute from said retrieved textual opinions; generating a list of textual quotations from said retrieved textual opinions; generating overall sentiment statistics; and generating a set of relevant background facts about said predetermined topic.

18. The computer readable medium of claim 15, further comprising computer executable instructions for aggregating multiple textual opinions on a topic received from a multiple sources over a communications network; converting each textual opinion into a standard format; and storing formatted opinion in said opinion database.

19. The computer readable medium of claim 15, further comprising computer executable instructions for distributing or transmitting said opinion summary to user over a communications network.

20. The computer readable medium of claim 15, further comprising computer executable instructions for soliciting opinions for insertion into said opinion database over said communications network; and receiving a request for an opinion summary from said user over said communications network.
